(19) United States
(12) Patent Application Publication
(10) Pub. No.: US 2013/0201166 A1
(43) Pub. Date: Aug. 8, 2013

(54) DISPLAY APPARATUS AND DRIVING METHOD THEREOF

(71) Applicants: Innocom Technology (Shenzhen) Co., Ltd., Shenzhen City (CN); Innolux Corporation, Chu-Nan (TW)

(72) Inventors: Chung-Yi WANG, Chu-Nan (TW); Yao-Lien HSIEH, Chu-Nan (TW); Bo-Chin TSUEI, Chu-Nan (TW); Jian-Cheng CHENG, Chu-Nan (TW)

(73) Assignees: INNOLUX CORPORATION, Chu-Nan (TW); INNOCOM TECHNOLOGY (SHENZHEN) CO., LTD., Shenzhen City (CN)

(21) Appl. No.: 13/755,799

(22) Filed: Jan. 31, 2013

(30) Foreign Application Priority Data
Feb. 2, 2012 (TW) 101103435

(51) Int. Cl. G09G 3/18

(52) U.S. Cl. CPC G09G 3/18
USPC 345/204; 345/87

(57) ABSTRACT

A method for driving a display apparatus includes a display panel, which at least includes a scan line, a data line, a control line and a pixel. The pixel has a first sub-pixel and a second sub-pixel. The first sub-pixel is electrically connected with the scan line and the data line. The second sub-pixel has a discharge switch and is electrically connected with the scan line, the data line and the control line. The driving method includes steps of providing a scan signal to drive the first and second sub-pixels through the scan line at a first time and providing a control signal to turn on the discharge switch of the second sub-pixel through the control line at a second time. A time difference between the first and second times is longer than the scan time of a scan line of the display apparatus.

### CROSS REFERENCE TO RELATED APPLICATIONS

This Non-provisional application claims priority under 35 U.S.C. §119(a) on Patent Application No(s). 101103435 filed in Taiwan, Republic of China on Feb. 2, 2012, the entire contents of which are hereby incorporated by reference.

### BACKGROUND OF THE INVENTION

1. Field of Invention

The invention relates to a display apparatus and a driving method thereof, and in particular, to a liquid crystal display apparatus and a driving method thereof.

2. Related Art

Liquid crystal display (LCD) apparatuses have been used in various electronic products and gradually replace the conventional cathode ray tube (CRT) display apparatuses due to the advantages, such as the low power consumption, the low generated heat, the light weight and the radiation-free properties.

In general, the LCD apparatus mainly includes a LCD panel and a backlight module. The LCD panel mainly has a thin film transistor substrate, a color filter substrate and a liquid crystal layer interposed between the two substrates. The two substrates and the liquid crystal layer form a plurality of pixels arranged in an array. The backlight module can uniformly distribute the light rays of a light source to the LCD panel, and form a pattern through each pixel displaying the color.

However, the voltage-transmittance curve of the pixel is changed as the angle of the user viewing the LCD panel is changed (e.g., from the front viewing angle to the side viewing angle). Thus, the color shift phenomenon occurs when the display panel is viewed at different viewing angles. In order to improve the color shift phenomenon, many prior arts have been developed, wherein most of the prior arts are characterized in that the single pixel is further divided into a bright area and a dark area. The mutual compensation performance is obtained to achieve the object of low color shift (LCS) according to the different voltage-transmittance curves for front viewing and side viewing in the two areas.

One prior art for dividing the single pixel into a bright area and a dark area to improve the color shift phenomenon is to use the charge sharing technology. Each pixel is further divided into a first sub-pixel and a second sub-pixel, and the charges stored in the liquid crystal capacitor of the second sub-pixel are shared with a storage capacitor, so that the liquid crystal capacitors of the first sub-pixel and the second sub-pixel have different data voltages. Then, the voltage difference between the data voltages of the first sub-pixel and the second sub-pixel is converted into different liquid crystal tilt angles to reach the bright area and the dark area, so that the different liquid crystal tilt angles in the two areas can compensate with each other and the low color shift performance can be obtained.

However, the side view performance of the liquid crystal display apparatus often has to be changed according to different requirements of different customers. The prior art is to change the size of the storage capacitor in the pixel when the display panel is being produced. This is because the different storage capacitors can make the first sub-pixel and the second sub-pixel have different display voltages and obtain different side view gamma curves. However, each time the size of the storage capacitor is changed, another patterned mask has to be used in the processes of manufacturing the display panel so that the manufacturing cost is significantly increased.

Therefore, it is an important subject to provide a display apparatus capable of adjusting a side-view gamma curve to change the side view performance without using a new mask and without significantly increasing the cost, and a method for driving the display apparatus.

### SUMMARY OF THE INVENTION

In view of the foregoing subject, an objective of the invention is to provide a display apparatus capable of adjusting a side-view gamma curve to change the side view performance without using a new mask and without significantly increasing the cost, and a method for driving the display apparatus.

To achieve the above objective, the present invention discloses a method for driving a display apparatus including a display panel, which comprises at least a scan line, at least a data line, at least a control line and at least a pixel. The pixel has a first sub-pixel and a second sub-pixel. The first sub-pixel is electrically connected with the scan line and the data line, and the second sub-pixel has a discharge switch and is electrically connected with the scan line, the data line and the control line. The method includes the steps of: transmitting a scan signal to drive the first sub-pixel and the second sub-pixel through the scan line at a first time; and transmitting a control signal to turn on the discharge switch of the second sub-pixel through the control line at a second time. Herein, a time difference between the first time and the second time is longer than a scan time of the scan line of the display apparatus.

In one embodiment, when the display panel has a plurality of the scan lines, the scan time is equal to a frame time of the display apparatus divided by the number of the scan lines.

In one embodiment, a minimum of the time difference is equal to one percent of the number of the scan lines multiplied by the scan time.

In one embodiment, a maximum of the time difference is equal to 0.2 times of the scan lines multiplied by the scan time.

In one embodiment, the time difference is adjustable.

In addition, the present invention also discloses a display apparatus comprising a display panel, a scan driving circuit, and a control driving circuit. The display panel includes at least a scan line, at least a data line, at least a control line, and at least a pixel. The pixel has a first sub-pixel and a second sub-pixel. The first sub-pixel is electrically connected with the scan line and the data line, and the second sub-pixel has a discharge switch and is electrically connected with the scan line, the data line and the control line. The scan driving circuit is electrically connected with the scan line, and transmits a scan signal to drive the first sub-pixel and the second sub-pixel through the scan line at a first time. The control driving circuit is electrically connected with the control line and transmits a control signal to turn on the discharge switch of the second sub-pixel through the control line at a second time. A time difference between the first time and the second time is longer than a scan time of the scan line of the display apparatus.

In one embodiment, when the display panel has a plurality of the scan lines, the scan time is equal to a frame time of the display apparatus divided by the number of the scan lines.

In one embodiment, a minimum of the time difference is equal to one percent of the number of the scan lines multiplied by the scan time.

In one embodiment, a maximum of the time difference is equal to 0.2 times of the scan lines multiplied by the scan time.

In one embodiment, the time difference is adjustable.

In one embodiment, the display panel further comprises a timing control circuit, which is electrically connected with the scan driving circuit and the control driving circuit, and controls timings of the first time and the second time and thus changes the time difference.

In one embodiment, the first sub-pixel has a first charge switch and a first liquid crystal capacitor, and the second sub-pixel further has a second charge switch, a second liquid crystal capacitor and a storage capacitor.

In one embodiment, the first charge switch is electrically connected with the scan line, the data line, the first liquid crystal capacitor and the second charge switch, the second charge switch is electrically connected with the scan line, the data line, the second liquid crystal capacitor and the discharge switch, and the discharge switch is electrically connected with the control line, the storage capacitor and the second liquid crystal capacitor.

In one embodiment, at the first time, the scan driving circuit transmits the scan signal to turn on the first charge switch and the second charge switch, and a data voltage is transmitted to the first liquid crystal capacitor and the second liquid crystal capacitor through the data line.

In one embodiment, at the second time, the control signal turns on the discharge switch so that charges stored in the second liquid crystal capacitor are shared with the storage capacitor.

As mentioned above, the display apparatus of the invention and the driving method thereof utilize the scan driving circuit to transmit a scan signal to drive the first sub-pixel and the second sub-pixel of the pixel through the scan line at the first time, and then utilize the control driving circuit to transmit the control signal to turn on the discharge switch of the second sub-pixel through the control line at the second time, wherein the time difference between the first time and the second time is longer than the scan time of one scan line of the display apparatus. Thus, changing the time difference between the first time and the second time can change the side-view gamma curve of the display apparatus, and thus change the side view performance of the display apparatus. Therefore, the display apparatus of the invention and the driving method thereof can adjust the side-view gamma curve thereof and thus change the side view performance thereof without using the new mask and significantly increasing the cost.

### BRIEF DESCRIPTION OF THE DRAWINGS

The invention will become more fully understood from the detailed description and accompanying drawings, which are given for illustration only, and thus are not limitative of the present invention, and wherein:

FIGS. 1 and 2 are a schematic illustration showing functional blocks of a display apparatus according to a preferred embodiment of the invention;

FIG. 3A is a schematic illustration showing a circuit of a pixel of FIG. 2;

FIG. 3B is a schematic illustration showing a scan signal and a control signal;

FIG. 4 is a schematic illustration showing a flow chart of a method for driving the display apparatus of the invention;

FIG. 5 is a schematic illustration showing different side-view gamma curves obtained at different delay times; and

FIG. 6 is a schematic illustration showing different LG curves obtained at different delay times.

### DETAILED DESCRIPTION OF THE INVENTION

The present invention will be apparent from the following detailed description, which proceeds with reference to the accompanying drawings, wherein the same references relate to the same elements.

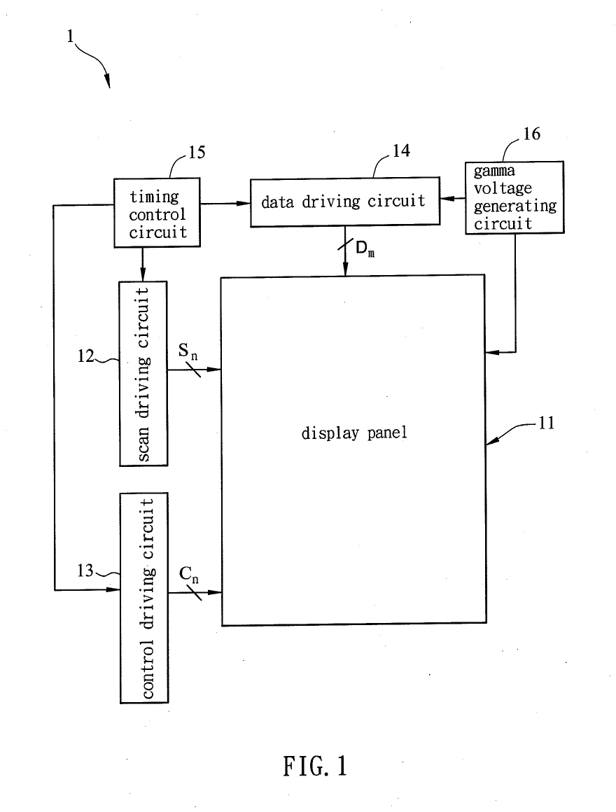

FIGS. 1 and 2 are a schematic illustration showing functional blocks of a display apparatus 1 according to a preferred embodiment of the invention. As shown in FIGS. 1 and 2, the display apparatus 1 is an active matrix liquid crystal display apparatus.

The display apparatus 1 includes a display panel 11, a scan driving circuit 12 and a control driving circuit 13. In addition, the display apparatus 1 may further include a data driving circuit 14, a timing control circuit 15 and a gamma voltage generating circuit 16.

The display panel 11 may include a thin film transistor substrate and a color filter substrate disposed opposite each other (not shown). In addition, the display panel 11 may further include at least a scan line, at least a data line, at least a control line and at least a pixel. As shown in the example of FIG. 2, the display panel 11 in this embodiment has a plurality of scan lines S₁ to Sₙ, a plurality of data lines D₁ to Dₘ, a plurality of control lines C₁ to Cₙ and a plurality of pixels P₁₁ to Pₙₘ. The scan lines S₁ to Sₙ and the data lines D₁ to Dₘ are disposed in a cross-interleaving manner to form the pixel arrays. The display panel 11 is electrically connected with the scan driving circuit 12, the data driving circuit 14 and the control driving circuit 13 through the scan lines S₁ to Sₙ, the data lines D₁ to Dₘ and the control lines C₁ to Cₙ, respectively. When the scan driving circuit 12 outputs a scan signal, the scan lines S₁ to Sₙ, are turned on, and the data driving circuit 14 transmits a data signal, corresponding to each column of pixels, to the pixels P₁₁ to Pₘ, through the data lines D₁ to Dₘ, so that the display panel 11 displays a frame. Each of the scan driving circuit 12 and the data driving circuit 14 may be an integrated circuit (IC) chip, and the scan driving circuit 12 and the data driving circuit 14 may also be integrated into an integrated circuit chip.

In addition, the timing control circuit 15 is electrically connected with the scan driving circuit 12, the control driving circuit 13 and the data driving circuit 14. The timing control circuit 15 transmits a vertical clock signal and a vertical sync signal to the scan driving circuit 12 and the control driving circuit 13, respectively, converts a video signal, received from an external interface, into a data signal (i.e., a gray level voltage) used by the data driving circuit 14, and transmits the data signal, a horizontal clock signal and a horizontal sync signal to the data driving circuit 14. In addition, the gamma voltage generating circuit 16 transmits a common voltage to a common electrode of the color filter substrate of the display panel 11, so that the liquid crystal operates according to the electric field formed by the common voltage of the common electrode and the voltage signal of the pixel electrode.

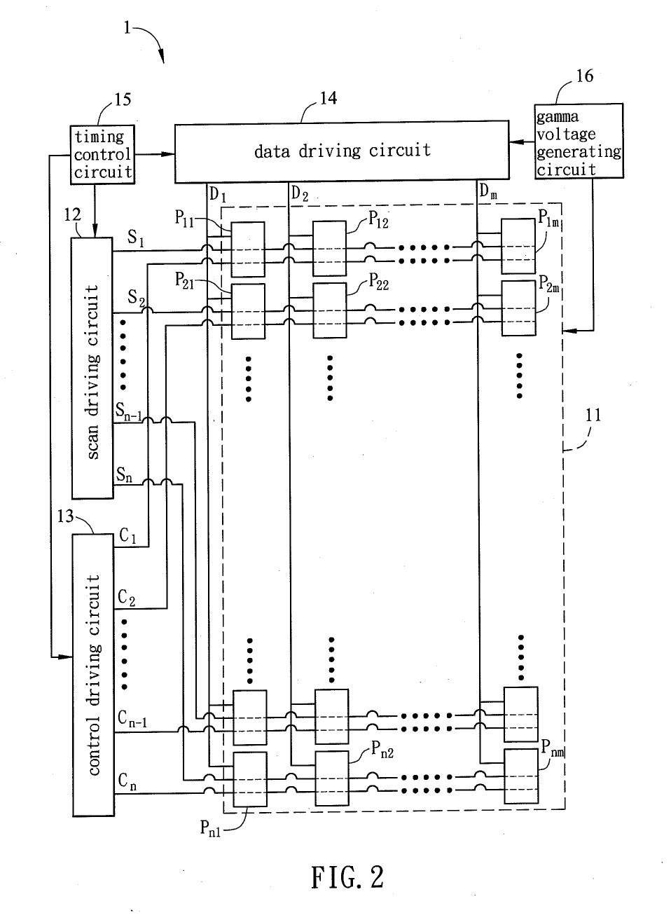

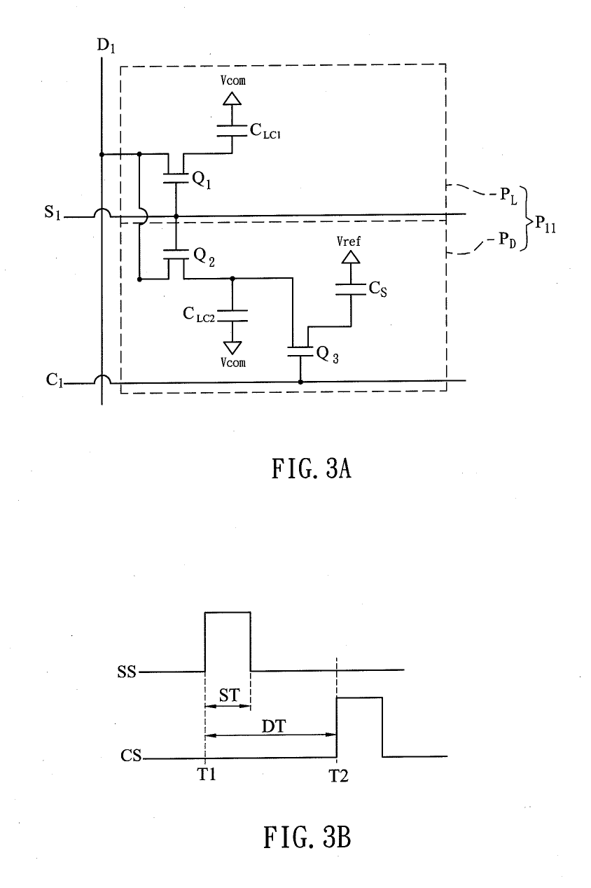

FIG. 3A is a schematic illustration showing a circuit of a pixel P₁₁ of FIG. 2. Referring to FIGS. 2 and 3A, the pixel P₁₁ includes a first sub-pixel P_{L} and a second sub-pixel P_{D}, the first sub-pixel P_{L} is electrically connected with the scan line S₁ and the data line D₁, and the second sub-pixel P_{D} is electrically connected with the scan line S₁, the data line D₁ and the control line C₁. The first sub-pixel P_{L} has a first charge switch Q₁ and a first liquid crystal capacitor C_{LC1}, and the second sub-pixel P_{D} has a second charge switch Q₂, a second liquid crystal capacitor C_{LC2}, a discharge capacitor C_{S} and a discharge switch Q₃. The first charge switch Q₁ is electrically connected with the scan line S₁, the data line D₁, the first liquid crystal capacitor C_{LC1} and the second charge switch Q₂, the second charge switch Q₂ is electrically connected with the scan line S₁, the data line D₁, the second liquid crystal capacitor C_{LC2} and the discharge switch Q₃, and the discharge switch Q₃ is electrically connected with the control line C₁, the discharge capacitor C_{S} and the second liquid crystal capacitor C_{LC2}. The other end of the discharge capacitor C_{S} is electrically connected with a reference voltage Vref, which can be a common electrode voltage Vcom, a low-level scan line voltage (or VGL), or any additional voltage.

The operation principle of the pixel P₁₁ will be described in the following. As shown in FIGS. 3A and 3B, at a first time T1, the scan driving circuit 12 transmits a scan signal SS to drive the first sub-pixel P_{L} and the second sub-pixel P_{D} through the scan line S₁, and can turn on the first charge switch Q₁ and the second charge switch Q₂ concurrently. At this time, the data signal (i.e., the gray level voltage) outputted from the data driving circuit 14 can charge the first liquid crystal capacitor C_{LC1} and the second liquid crystal capacitor C_{LC2} through the data line D₁, so that the first and second liquid crystal capacitors C_{LC1} and C_{LC2} of the first and second sub-pixels P_{L} and P_{D} have the same voltage.

Next, at a second time T2, the control driving circuit 13 may transmit a control signal CS to turn on the discharge switch Q₃ of the second sub-pixel P_{D} through the control line C₁. At this time, the charges of the second liquid crystal capacitor C_{LC2} are shared with the discharge capacitor C_{S} through the discharge switch Q₃, and finally the voltages of the second liquid crystal capacitor C_{LC2} and the discharge capacitor C_{S} are balanced. Thus, the first liquid crystal capacitor C_{LC1} and the second liquid crystal capacitor C_{LC2} may have different voltages. Because the first liquid crystal capacitor C_{LC1} and the second liquid crystal capacitor C_{LC2} have different voltages, the pixel P₁₁ has the first sub-pixel P_{L} and the second sub-pixel P_{D} with two different display voltages, and can convert the voltage differences between the two areas of the first sub-pixel P_{L} and the second sub-pixel P_{D} into different liquid crystal tilt angles to achieve the objects of the bright area and the dark area. Because the different liquid crystal tilt angles in the two areas of the first sub-pixel P_{L} and the second sub-pixel P_{D} can mutually compensate and thus reach the bright area and the dark area, the display apparatus 1 may achieve the performance of low color shift. In addition, the circuits of the pixels P₁₂ to Pₙₘ of FIG. 2 and the operation principles thereof may be referred to those of pixel P₁₁, and detailed descriptions thereof will be omitted.

Most important of all, a time difference (hereinafter referred to as the delay time DT) between the first time T1 and the second time T2 is longer than a scan time (ST) of a scan line of the display apparatus 1. One scan time ST is equal to one frame time of the display apparatus 1 divided by the number of the scan lines S₁ to Sₙ. Herein, the frame time does not contain the blanking time and is equal to the period for actually displaying a screen. Specifically, taking a full high definition (FHD) display apparatus with a refresh rate of 120 Hz as an example, it has 1080 scan lines, and its frame time is 1/120=8.33 milliseconds (ms). So, one scan time ST is equal to 8.33 ms/1080=7.7 microsecond (μs). Thus, the time differences (i.e., the delay times DT) between the times of the scan lines S₁ to Sₙ for outputting the scan signal SS of the invention and the times of the control lines C₁ to Cₙ of the same pixel for outputting the control signal CS, respectively, exceed one scan time ST of the scan line, and the time difference is adjustable. For example, the delay time DT may be equal to 2, 5, 10, 50, 100 times of the scan time ST. In addition, this invention is also not restricted to the integer times of the scan time. For example, the delay time Dt may be equal to 10.2, 50.5 times of the scan time ST or the liked. Herein, the invention is not particularly restricted thereto.

Preferably, the minimum of the delay time DT may be one percent of the number of the scan lines S₁ to Sₙ multiplied by one scan time ST. Still taking the FHD display apparatus with the refresh rate of 120 Hz as an example, the minimum of the delay time DT may be equal to 1080 divided by 100 and multiplied by one scan time ST (7.7 μs), and is thus equal to 10.8×7.7 μs. If the integer is taken, then the preferred delay time DT may be longer than or equal to 10 times of the scan time ST. In addition, the maximum of the delay time DT may be equal to 0.2 times of the number of the scan lines S₁ to Sₙ multiplied by one scan time ST. So, the maximum of the delay time DT may be equal to 1080 divided by 5 and multiplied by one scan time ST (7.7 μs) and is thus equal to 216×7.7 μs. Therefore, the preferred delay time DT of the invention is smaller than or equal to 216 times of the scan time ST. As mentioned hereinabove, the preferred delay time DT of the invention may range between one percent of the number of scan lines multiplied by one scan time and 0.2 times of the number of scan lines multiplied by one scan time. However, in other embodiments, the minimum of the time difference is equal to at least two scan lines multiplied by the scan time.

The invention can control the timings of outputting the first time T1 and the second time T2 through the timing control circuit 15, and thus change the delay time DT. In other words, the timing control circuit 15 may be utilized to control the time difference (delay time DT) between the time of the scan driving circuit 12 of transmitting the scan signal SS to the first sub-pixel P_{L} through the scan line and the changed time of the control driving circuit 13 of transmitting the control signal CS to the second sub-pixel P_{D} through the control line, and the different delay time DT can make the display apparatus 1 achieve the object of low color shift.

When the delay time DT is changed, the times of making the first sub-pixel P_{L} and the second sub-pixel P_{D} have different voltage differences are also changed. Still taking the FHD display apparatus with the refresh rate of 120 Hz as an example, when the delay time DT is equal to one scan time ST, the time of feeling the low color shift is equal to 1079/1080×8.33 ms in one frame time (8.33 ms) of the display apparatus. However, when the delay time DT is equal to 540 times of the scan time ST, for example, the observer may feel low color shift for the time equal to 540/1080×8.33 ms. This also represents that, in one frame time, the low color shift performance is felt in a half time, and is not felt in the other half time. So, the low color shift performance felt by the observer is different from that felt when the delay time DT is equal to one scan time ST. Thus, the object of changing the side view performance of the display apparatus can be changed by controlling the delay time DT.

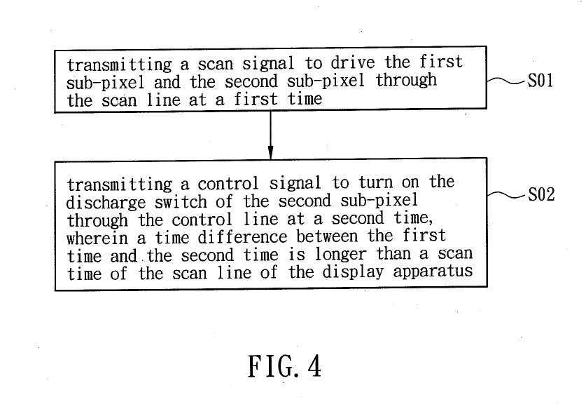

The method for driving the display apparatus 1 of the invention will be described with reference to FIGS. 3A, 3B and 4. FIG. 4 is a schematic illustration showing a flow chart of a method for driving the display apparatus of the invention. The elements of the display apparatus 1 and connections therebetween have been described hereinabove, so detailed descriptions thereof will be omitted.

The method for driving the display apparatus 1 includes steps S01 and S02.

In the step S01, a scan signal SS is transmitted to drive the first sub-pixel P_{L} and the second sub-pixel P_{D} through the scan line S₁ at a first time T1. Herein, the first charge switch Q₁ and the second charge switch Q₂ are concurrently turned on, and the data signal outputted from the data driving circuit 14 can charge the first liquid crystal capacitor C_{LC1} and the second liquid crystal capacitor C_{LC2} through the data line D₁, so that the first and second liquid crystal capacitors C_{LC1} and C_{LC2} of the first and second sub-pixels P_{L} and P_{D} have the same voltage.

In addition, in the step S02, a control signal CS is transmitted to turn on the discharge switch Q₃ of the second sub-pixel P_{D} through the control line C₁ at a second time T2. A time difference (i.e., the delay time DT) between the first time T1 and the second time T2 is longer than the scan time ST of one scan line of the display apparatus 1. Herein, the charges of the second liquid crystal capacitor C_{LC2} of the second sub-pixel P_{D} are shared with the discharge capacitor C_{S} through the discharge switch Q₃, and finally the voltages of the second liquid crystal capacitor C_{LC2} and the discharge capacitor C_{S} are balanced. When the display panel 11 has a plurality of scan lines, the scan time ST is equal to a frame time of the display apparatus 1 divided by the number of the scan lines S₁ to S. In addition, the minimum of the time difference is equal to one percent of the number of the scan lines S₁ to Sₙ multiplied by the scan time ST, the maximum of the time difference is equal to 0.2 times of the number of the scan lines S₁ to Sₙ multiplied by the scan time ST, and the time difference is adjustable. Otherwise, the minimum of the time difference can be equal to at least two scan lines S₁ to Sₙ multiplied by the scan time ST.

In addition, the other technical features of the method for driving the display apparatus 1 are referred to the above mentioned embodiment, so the detailed description thereof is omitted.

In addition, the frequently seen method of quantitating the side view performance of the display apparatus uses the Delta Local Gamma (hereinafter referred to as D_LG), and the D_LG value serves as the specification for the side view performance. For example, the D_LG value requested by SONY cooperation is 0.8<D_LG<1, and other companies require different ranges of the D_LG values.

The local gamma (LG) is defined as:

$$LG ( gray ) ≡ \frac{log ( L ( gray + 8 ) ) - log ( L ( gray ) )}{log ( gray + 8 ) - log ( gray )}$$

That is, the log of the gamma curve of the display apparatus is taken and then the slope of the logged gamma curve is calculated. In addition, the D_LG is defined as the difference between the maximum LG value and the minimum LG value for the gray-scale value ranging from 32 and 192. Therefore, the D_LG value can be changed as long as the LG curve is changed.

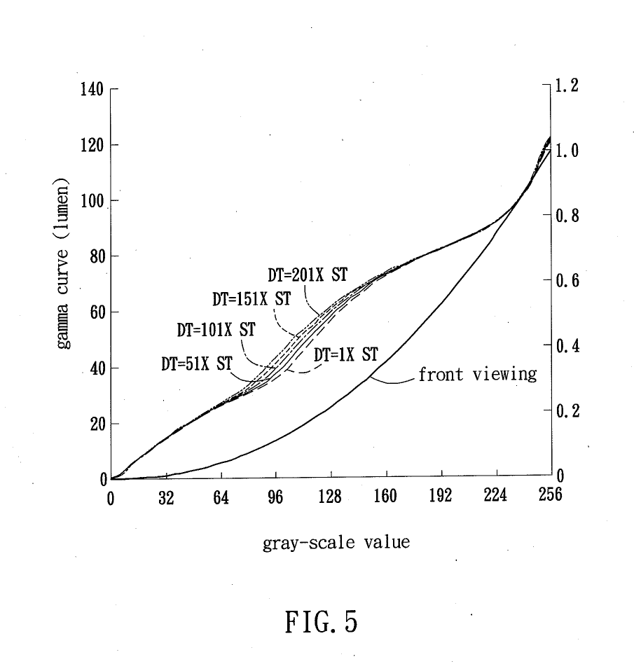

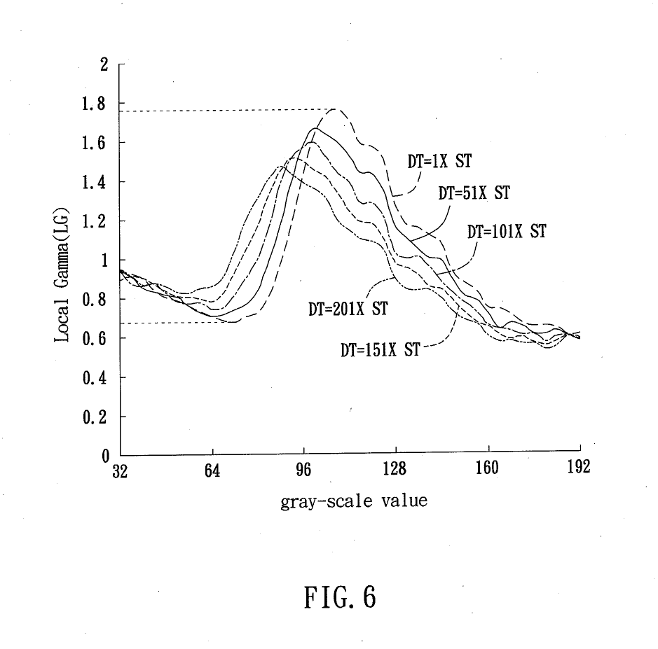

Illustrations of the invention will be made with reference to FIGS. 5 and 6, in which the gamma curve is adjusted by changing the delay time DT and the LG and D_LG results are also changed accordingly. FIG. 5 is a schematic illustration showing different side-view gamma curves obtained at different delay times, and FIG. 6 is a schematic illustration showing different LG curves obtained at different delay times. Herein, different side-view gamma curves and LG curves are obtained according to the delay times DT equal to 1, 51, 101, 151 and 201 times of the scan time ST, respectively.

As shown in FIG. 5, a different gamma curve may be obtained by changing the delay time DT (i.e., different gamma curves are obtained according to different delay times DT) in the display apparatus 1. For example, different gamma curves are obtained when the delay time DT of FIG. 5 is equal to 1 time, 51 times, 101 times, 151 times or 201 times of the scan time ST. In addition, the log of the gamma curve of FIG. 5 is taken, and then the slope at each gray level of the logged gamma curve is calculated to obtain different LG curves in FIG. 6. It is obviously found that the difference between the maximum LG value and the minimum LG gets smaller as the multiple of the delay time DT gets higher. In addition, when the delay time DT is changed, the difference between the maximum LG value and the minimum LG value can be changed. That is, the D_LG value can be changed, and thus the side view performance of the display apparatus 1 can be changed.

Therefore, the display apparatus 1 of the invention and the driving method thereof can change the delay time DT by controlling the time of the scan driving circuit 12 for transmitting the scan signal SS to the first sub-pixel P_{L} of the pixel and the time of the control driving circuit 13 for transmitting the control signal CS to the second sub-pixel P_{D}. The change of the delay time DT can change the gamma curve of the display apparatus 1. So, the side view performance of the display apparatus 1 can be changed without using the new mask and significantly increasing the cost.

In summary, the display apparatus of the invention and the driving method thereof utilize the scan driving circuit to transmit a scan signal to drive the first sub-pixel and the second sub-pixel of the pixel through the scan line at the first time, and then utilize the control driving circuit to transmit the control signal to turn on the discharge switch of the second sub-pixel through the control line at the second time, wherein the time difference between the first time and the second time is longer than the scan time of one scan line of the display apparatus. Thus, changing the time difference between the first time and the second time can change the side-view gamma curve of the display apparatus, and thus change the side view performance of the display apparatus. Therefore, the display apparatus of the invention and the driving method thereof can adjust the side-view gamma curve thereof and thus change the side view performance thereof without using the new mask and significantly increasing the cost.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A method for driving a display apparatus comprising a display panel, the display panel comprising at least a scan line, at least a data line, at least a control line and at least a pixel, the pixel having a first sub-pixel and a second sub-pixel, the first sub-pixel being electrically connected with the scan line and the data line, the second sub-pixel having a discharge switch and being electrically connected with the scan line, the method comprising the steps of:
transmitting a scan signal to drive the first sub-pixel and the second sub-pixel through the scan line at a first time; and
transmitting a control signal to turn on the discharge switch of the second sub-pixel through the control line at a second time, wherein a time difference between the first time and the second time is longer than a scan time of the scan line of the display apparatus.

2. The method according to claim 1, wherein when the display panel has a plurality of the scan lines, the scan time is equal to a frame time of the display apparatus divided by the number of the scan lines.

3. The method according to claim 2, wherein a minimum of the time difference is equal to one percent of the number of the scan lines multiplied by the scan time.

4. The method according to claim 2, wherein a minimum of the time difference is equal to at least two scan lines multiplied by the scan time.

5. The method according to claim 2, wherein a maximum of the time difference is equal to 0.2 times of the scan lines multiplied by the scan time.

6. The method according to claim 1, wherein the time difference is adjustable.

7. A display apparatus, comprising:
a display panel, comprising:
at least a scan line,
at least a data line,
at least a control line, and
at least a pixel having a first sub-pixel and a second sub-pixel, wherein the first sub-pixel is electrically connected with the scan line and the data line, and the second sub-pixel has a discharge switch and is electrically connected with the scan line, the data line and the control line;
a scan driving circuit, which is electrically connected with the scan line, and transmits a scan signal to drive the first sub-pixel and the second sub-pixel through the scan line at a first time; and
a control driving circuit, which is electrically connected with the control line and transmits a control signal to turn on the discharge switch of the second sub-pixel through the control line at a second time,
wherein a time difference between the first time and the second time is longer than a scan time of the scan line of the display apparatus.

8. The apparatus according to claim 7, wherein when the display panel has a plurality of the scan lines, the scan time is equal to a frame time of the display apparatus divided by the number of the scan lines.

9. The apparatus according to claim 8, wherein a minimum of the time difference is equal to one percent of the number of the scan lines multiplied by the scan time.

10. The apparatus according to claim 8, wherein a minimum of the time difference is equal to at least two scan lines multiplied by the scan time.

11. The apparatus according to claim 8, wherein a maximum of the time difference is equal to 0.2 times of the scan lines multiplied by the scan time.

12. The apparatus according to claim 7, wherein the time difference is adjustable.

13. The apparatus according to claim 7, wherein the display panel further comprises a timing control circuit, which is electrically connected with the scan driving circuit and the control driving circuit, and controls timings of the first time and the second time and thus changes the time difference.

14. The apparatus according to claim 7, wherein the first sub-pixel has a first charge switch and a first liquid crystal capacitor, and the second sub-pixel further has a second charge switch, a second liquid crystal capacitor and a discharge capacitor.

15. The apparatus according to claim 14, wherein the first charge switch is electrically connected with the scan line, the data line, the first liquid crystal capacitor and the second charge switch, the second charge switch is electrically connected with the scan line, the data line, the second liquid crystal capacitor and the discharge switch, and the discharge switch is electrically connected with the control line, the discharge capacitor and the second liquid crystal capacitor.

16. The apparatus according to claim 14, wherein at the first time, the scan driving circuit transmits the scan signal to turn on the first charge switch and the second charge switch, and a data voltage is transmitted to the first liquid crystal capacitor and the second liquid crystal capacitor through the data line.

17. The apparatus according to claim 14, wherein at the second time, the control signal turns on the discharge switch so that charges stored in the second liquid crystal capacitor are shared with the discharge capacitor.
